(19) United States
(12) Patent Application Publication
(10) Pub. No.: US 2013/0327183 A1
(43) Pub. Date: Dec. 12, 2013

(54) PORTABLE DATA STORAGE DEVICE EQUIPPED WITH A BOTTLE OPENING FUNCTION

(71) Applicant: Hsieh Tai-Kao, Hsinchu County (TW)

(72) Inventor: Hsieh Tai-Kao, Hsinchu County (TW)

(21) Appl. No.: 13/492,226

(22) Filed: Jun. 8, 2012

(51) Int. Cl. B67B 7/44

(52) U.S. Cl. 81/3.09

(57) ABSTRACT

A portable data storage device equipped with a bottle opening function is to open a bottle cap fastened on a bottle. The portable data storage device includes a body, a storage element, a bottle opening set and a movable set. The body has a distal end with a front area and a rear area adjacent to the front area. The storage element is held in the body. The bottle opening set is connected to the distal end and includes a claw opener located on the front area and a press member located on the rear area that has a press end remote from the body. The claw opener has a claw latch end formed lower than the press end. The movable set is located movably between the press end and claw latch end. The data storage device thus formed has data access and bottle opening functions.

### FIELD OF THE INVENTION

The present invention relates to a storage device and particularly to a storage device equipped with a bottle opening function.

### BACKGROUND OF THE INVENTION

In the modern society advances of technology and development of information digitization have made people increasingly relying on electronic devices such as desktop computers, notebook computers, tablet computers, smartphones and the like to read and edit data documents. To facilitate data access and carrying, the most commonly used and handy device is flash drive.

A conventional flash drive, such as one disclosed in U.S. publication No. 2006/0136623, mainly includes a storage unit held in a housing and a transmission connector located on the housing to plug to other electronic devices for coupling or unplug therefrom for decoupling. The housing has a base casing, an end cap and a housing cap. The base casing and end cap can form a housing compartment to hold a memory module and allow a USB interface connector to be extended outside the end cap to form electric connection with other electronic products. When not in use it is closed via the housing cap to provide protection.

These days information digitization almost becomes ubiquitous, and many people carry a flash drive most of the time. Some people even couple the flash drive with a string of keys. As the present flash drive provides only a single function of data access, in view of an article many people carrying most of the time, there is still room for improvement.

### SUMMARY OF THE INVENTION

The primary object of the present invention is to provide improvement over the conventional flash drive which provides merely a single function of data access.

To achieve the foregoing object, the present invention provides a portable data storage device equipped with a bottle opening function to open a bottle cap fastened on a bottle. The bottle cap has a top surface and an outer rim surrounding the top surface. The portable data storage device includes a body, a storage element, a bottle opening set and a movable set. The body has a distal end which includes a front area and a rear area adjacent to the front area. The storage element is held in the body. The bottle opening set is connected to the distal end of the body and includes a claw opener located on the front area and a press member located on the rear area that has a press end remote from the body. The claw opener has a claw latch end formed at an elevation lower than that of the press end. The movable set is located between the press end and claw latch end.

The movable set includes an initial state positioned between the press end and claw latch end and a bottle opening state pressed by the bottle cap to leave the position between the press end and the claw latch end to allow the press end to press the top surface and the claw latch end to hook the outer rim to disengage the bottle cap from the bottle.

In short, through the bottle opening set, the invention can provide many advantages, notably:

1. The portable data storage device is equipped with not only the data access function, but also the bottle opening function.

2. At the initial state, the movable set can avoid the claw opener from hurting people.

3. At the initial state the press member can be used to hang an object.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of an embodiment of the invention.

FIG. 2A is a schematic view of an embodiment of the invention at the initial state.

FIG. 2B is a schematic view of an embodiment of the invention at the bottle opening state.

### DETAILED DESCRIPTION OF THE PREFERRED EMBODIMENT

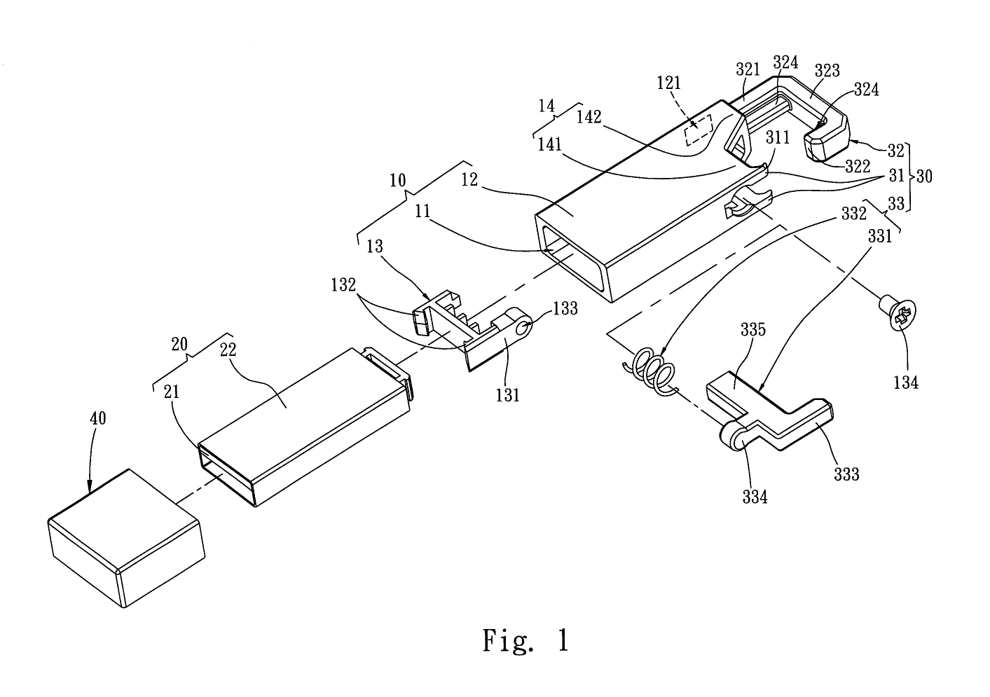

Please refer to FIG. 1 for an embodiment of the portable data storage device equipped with a bottle opening function of the invention. It includes a body 10, a storage element 20, a cap 40 and a bottle opening set 30. The body 10 has a distal end 14 which includes a front area 141 and a rear area 142 adjacent to the front area 141. The body 10 also includes a housing compartment 11, a housing 12 encasing the housing compartment 11 and a holding member 13 located in the housing compartment 11. The holding member 13 includes a fastening portion 131 and a latch portion 132. The fastening portion 131 has a screw hole 133 fastened by a mating screw 134 to allow the holding portion 13 to be held in the housing compartment 11 of the housing 12. The latch portion 132 has two latch tenons that are extended towards each other to latch the storage element 20. The storage element 20 is located in the housing compartment 11 and connected to the holding member 13 and extended outside the body 10. The storage element 20 includes a USB 21 and a connection hub 22 encasing the USB 21. The cap 40 is coupled with the body 10. In this embodiment, the cap 40 is coupled with the housing 12 to encase the storage element 20 extended outside the housing 12.

The bottle opening set 30 is connected to the distal end 14 of the body 10 and includes a claw opener 31, a press member 32 and a movable set 33. The claw opener 31 is located on the front area 141. In this embodiment, the claw opener 31 is jutted outwards from the front area 141 and shrunk gradually to form a claw latch end 311. The press member 32 is located on the read area 142 and formed by extending from the housing 12 to include a connection end 321, a press end 322 and a shank 323 bridging the connection end 321 and press end 322. The connection end 321 is connected to the rear area 142. The press end 322 is extended from the shank 323 and remote from the body 10. The press end 322 is formed at a higher elevation than the claw latch end 311. In this embodiment, the shank 323 forms two bend portions. The press end 322 opposes the claw latch end 311. Moreover, the press end 322 has an inclined surface corresponding to the top surface of the bottle cap 60 and press thereon to apply a force. Each bend portion has a reinforcing member 324 to enhance the strength of the shank 323.

The movable set 33 is movably located between the press end 322 and claw latch end 311, and includes a retaining member 331 and an elastic element 332. The retaining member 331 is movable between the claw opener 31 and press member 32, and includes a barrier portion 333 slidable between the press end 322 and claw latch end 311, a positioning portion 334 butted by the elastic element 332 and a connecting portion 335 connected to the barrier portion 333 and positioning portion 334. The connecting portion 335 corresponding to a hole 121 formed on the housing 12 and can run through thereof. The elastic element 332 is located in the housing compartment 11 with one end butting an inner side of the housing 12 and another end butting the positioning portion 334 of the retaining member 331 so that the barrier portion 333 can be moved and positioned between the press end 322 and claw latch end 311, or moved away from the position between the press end 322 and claw latch end 311.

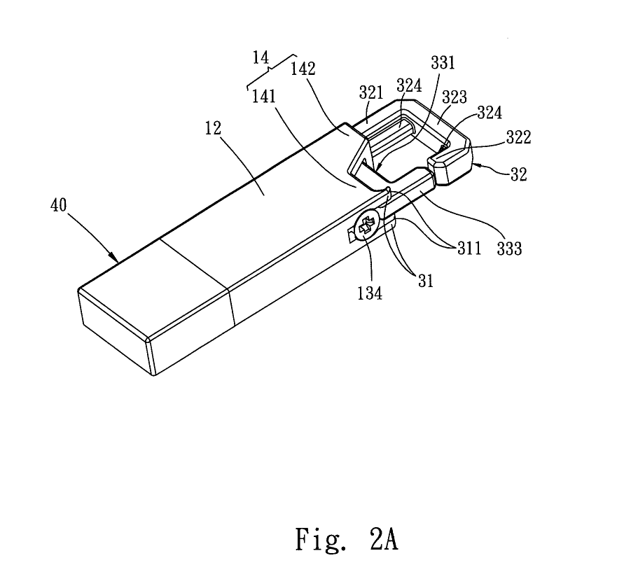

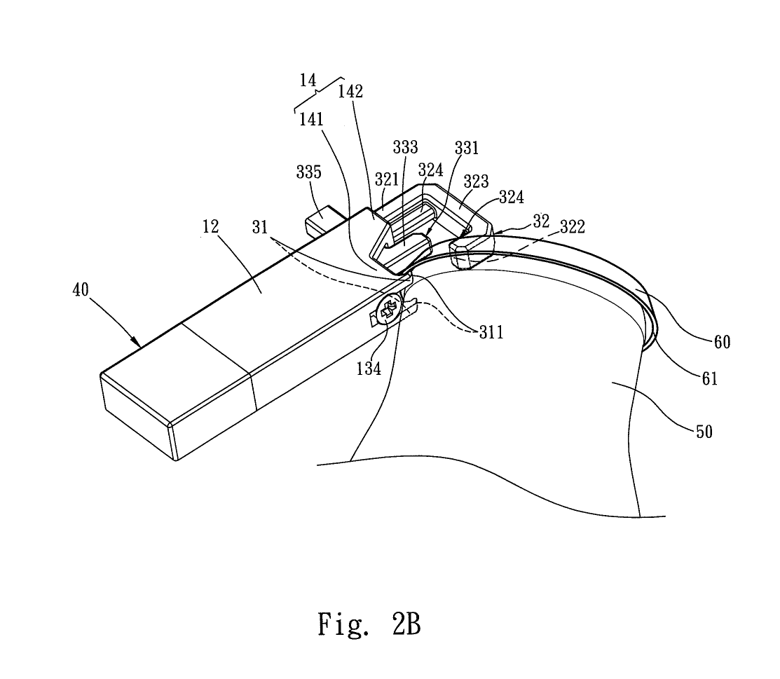

Also refer to FIGS. 2A and 2B for an initial state and a bottle opening state of an embodiment of the invention. At the initial state as shown in FIG. 2A, the movable set 33 is positioned between the press end 322 and claw latch end 311; the elastic element 332 presses the positioning member 334 of the retaining member 331 so that the barrier portion 333 is moved between the press end 322 and claw latch end 311; thereby the retaining member 331 can prevent people from incidentally entering between the press end 322 and claw latch end 311 and be injured by a sharp end of the claw latch end 311; moreover, the retaining member 331 and press member 32 jointly form an annular latch ring to hang an article, such as a key, ornamental article or the like.

Referring to FIG. 2B, the bottle cap 60 has a top surface and an outer rim 61 surrounding the top surface. The movable set 33 is pushed by the bottle cap 60 to move away from between the press end 322 and claw latch end 311. More specifically, the retaining member 331 is pushed by the bottle cap 60 to move inwards, and the positioning portion 334 compresses the elastic element 332, and then the connecting portion 335 passes through the hole 121, and the barrier portion 333 is moved away from the position between the press end 322 and claw latch end 311 so that the inclined surface of the press end 322 presses the top surface of the bottle cap 60, while the claw opener 31 hooks the position between the outer rim 61 and bottle 50, thereby by applying a force on the claw latch end 311 the bottle cap 60 can be opened to escape from the bottle 50.

In short, by providing a bottle opening set in the invention, the portable data storage device is equipped with not only the data access function, but also the bottle opening function. Moreover, at the initial state, the movable set can prevent people from entering between the press end and claw latch end to avoid injury by the claw opener, and the movable set and press end also can form an annular ring to hang on an article. Thus the invention provides significant improvements over the conventional techniques.

While the preferred embodiment of the invention has been set forth for the purpose of disclosure, it is not the limitation of the invention, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A portable storage device equipped with a bottle opening function to open a bottle cap fastened on a bottle, the bottle cap including a top surface and an outer rim surrounding the top surface, the portable storage device comprising:
a body and a storage element located in the body, the body including a distal end with a front area and a rear area adjacent to the front area;
a bottle opening set connecting to the distal end of the body and including a claw opener on the front area, a press member on the rear area that includes a press end remote from the body, the claw opener including a claw latch end formed at an elevation lower than that of the press end; and
a movable set which is located movably between the press end and the claw latch end and includes an initial state positioned between the press end and the claw latch end and a bottle opening state pressed by the bottle cap to leave the position between the press end and the claw latch end to allow the press end to press the top surface and the claw latch end to hook the outer rim to remove the bottle cap from the bottle.

2. The portable storage device of claim 1, wherein the body includes a housing compartment and a housing encasing the housing compartment, the storage element being held in the housing compartment and extensible outside the housing.

3. The portable storage device of claim 2, wherein the body further includes a holding member located in the housing compartment, the holding member including a fastening portion connecting to the housing and a latch portion connecting to the storage element.

4. The portable storage device of claim 3, wherein the holding member is fastened to the housing through the fastening portion via a screw.

5. The portable storage device of claim 1, wherein the storage element includes a Universal Serial Bus and a connection hub encasing the Universal Serial Bus.

6. The portable storage device of claim 2, wherein the movable set includes a retaining member movable between the claw opener and the press member and an elastic element held in the housing compartment with one end butting the body and another end butting the retaining member.

7. The portable storage device of claim 6, wherein the retaining member includes a barrier portion slidable between the press end and the claw latch end, a positioning portion butted by the elastic element and a connecting portion connecting to the barrier portion and the positioning portion.

8. The portable storage device of claim 1 further including a cap coupled on the body to encase the storage element extended outside the body.

9. The portable storage device of claim 1, wherein the press member includes a reinforcing member at a bend portion thereof.
